(19) United States
(12) Patent Application Publication
(10) Pub. No.: US 2014/0075140 A1
(43) Pub. Date: Mar. 13, 2014

(54) SELECTIVE CONTROL FOR COMMIT LINES FOR SHADOWING DATA IN STORAGE ELEMENTS

(71) Applicants: Ingo Schmiegel, Braunschweig (DE); Karsten Stangel, Braunschweig (DE)

(72) Inventors: Ingo Schmiegel, Braunschweig (DE); Karsten Stangel, Braunschweig (DE)

(21) Appl. No.: 13/976,510

(22) PCT Filed: Dec. 30, 2011
(86) PCT No.: PCT/US11/68132

§ 371 Date: Nov. 6, 2013

(51) Int. Cl. G06F 3/06

(52) U.S. Cl. CPC G06F 3/065; G06F 3/0614; G06F 3/0683
USPC 711/162

(57) ABSTRACT

Systems and methods to selectively apply commit and rollback operations between a backup memory and a primary memory are implemented. For each entry in the primary memory, a monitor may be implemented to track the state of the entry. The state may indicate that the entry has changed upon execution of a write command for the entry. The state may be reset upon execution of a commit or rollback command. The primary memory may be a storage array coupled to a backup memory. The backup memory may be a shadow storage element.

### FIELD OF THE INVENTION

Aspects of the present invention relate generally to the field of memory storage and more specifically to improving processing efficiency in memory backup techniques.

### BACKGROUND

In memory storage systems having a backup element, the backup element may reflect a memory state unaffected by recent updates to the main memory element. Then changes to data may be saved to backup memory storage permanently with a commit operation or undone with a rollback or restore operation. After a series of writes or other edits are made to primary memory, the changes are committed to the backup element to reflect the current state of the primary memory upon the implementation of a commit operation. Alternately, the backup element provides a clean copy to which the primary memory may be returned upon implementation of a rollback or restore operation.

Storage elements may have a shadow element as a backup, for example a register file or small signal array may be implemented with a storage array. Write operations then change the data in the primary storage array. Then a commit operation copies the data in the primary storage array to the shadow element, such that the shadow element reflects the current state of the primary storage array. Similarly, a rollback or restore operation copies the data stored in the shadow element to the primary storage array, such that the primary storage array reflects the current state of the shadow element. The commit and rollback operations conventionally occur at specific predetermined intervals, effect the entire storage array, and are implemented to save or rollback the changes caused by the write operations.

However, due to the amount of data being copied, the commit and rollback functions utilize significant processing resources and have a higher peak power usage than other memory functions. Additionally, the resources expended with each commit or rollback operation are increasing as the size of a typical storage array size increases.

Therefore, there is a need in the art to more efficiently manage the commit and rollback operations in a memory storage array.

### BRIEF DESCRIPTION OF THE DRAWINGS

Embodiments are illustrated by way of example and not limitation in the Figures of the accompanying drawings:

FIG. 1 is a block diagram of a system according to an embodiment;

FIG. 2 is a block diagram of a processor according to an embodiment;

FIG. 3 illustrates an exemplary storage array according to an embodiment;

FIG. 4 illustrates an exemplary control logic for a storage array according to an embodiment;

FIG. 5 illustrates an exemplary entry status monitor (ESM) according to an embodiment;

FIG. 6 is a flow diagram that illustrates an exemplary method for managing a storage array according to an embodiment;

### DETAILED DESCRIPTION

The following description describes systems and methods to selectively apply commit and rollback operations to and from a shadow storage element. The shadow storage element may be coupled to a primary memory. According to an embodiment, the primary memory may be a storage array. For each entry in a primary memory, a monitor may be implemented to track the state of the entry. The state may indicate that the entry has changed upon execution of a write command for the entry or has been updated upon execution of a commit or rollback command.

Embodiments include storage arrays implemented within or in association with a processor, computer system, or other processing apparatus. According to an embodiment, a system having a processor and a first and a second memory may be implemented to selectively apply commit and rollback operations. The first memory may include a plurality of monitors configured to monitor a change state for each entry in the first memory. The processor may include an execution unit configured to execute commands to read and write data to the first and second memory, wherein a command to access the second memory is executed only for the entries in the first memory having a change state that indicates the entry has been changed. Suppressing or skipping the command to access the second memory for each entry that had not been changed may save significant resources, including switching activity and power consumption.

According to an embodiment, a processor having a primary and a backup memory may be implemented to selectively apply commit and rollback operations. The processor may additionally include a plurality of monitors coupled to a plurality of entries in the primary memory configured to monitor a change state for each entry. An execution unit of the processor may execute a command to access the backup memory only for those entries for which the change state indicates the entry has been changed.

According to an embodiment, a non-transitory machine-readable medium may store data that, when performed by a machine, causes the machine to fabricate at least one integrated circuit to perform a method to selectively apply commit and rollback operations. The method may include monitoring a change state for a plurality of entries in a primary storage element and upon receipt of an instruction comprising a request to access a backup storage element, checking the change state for each entry in the primary storage element for which the request applies. If the change state indicates the entry has been changed, the received instruction may be executed for that entry.

In the following description, numerous specific details such as processing logic, processor types, micro-architectural conditions, events, enablement mechanisms, and the like are set forth in order to provide a more thorough understanding of embodiments of the present invention. It will be appreciated, however, by one skilled in the art that the invention may be practiced without such specific details. Additionally, some well-known structures, circuits, and the like have not been shown in detail to avoid unnecessarily obscuring embodiments of the present invention.

Although the following embodiments are described with reference to a processor, other embodiments are applicable to other types of integrated circuits and logic devices. Similar techniques and teachings of embodiments of the present invention can be applied to other types of circuits or semiconductor devices that can benefit from reduced memory operations and improved performance. The teachings of embodiments of the present invention are applicable to any processor or machine that performs memory storage manipulations with a shadow element. The following description provides examples, and the accompanying drawings show various examples for the purposes of illustration. However, these examples should not be construed in a limiting sense as they are merely intended to provide examples of embodiments of the present invention rather than to provide an exhaustive list of all possible implementations of embodiments of the present invention.

Although the below examples describe memory storage manipulation in the context of storage arrays, other embodiments of the present invention can be accomplished by way of a data or instructions stored on a machine-readable, tangible medium, which when performed by a machine cause the machine to perform functions consistent with at least one embodiment of the invention. In one embodiment, functions associated with embodiments of the present invention are embodied in machine-executable instructions. The instructions can be used to cause a general-purpose or special-purpose processor that is programmed with the instructions to perform the steps of the present invention. Embodiments of the present invention may be provided as a computer program product or software, which may include a machine or computer-readable medium having stored thereon instructions which may be used to program a computer (or other electronic devices) to perform one or more operations according to embodiments of the present invention. Alternatively, steps of embodiments of the present invention might be performed by specific hardware components that contain fixed-function logic for performing the steps, or by any combination of programmed computer components and fixed-function hardware components.

Instructions used to program logic to perform embodiments of the invention can be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present invention.

In modern processors, a number of different execution units are used to process and execute a variety of code and instructions. Not all instructions are created equal as some are quicker to complete while others can take a number of clock cycles to complete. The faster the throughput of instructions, the better the overall performance of the processor. Thus it would be advantageous to have as many instructions execute as fast as possible. However, there are certain instructions that have greater complexity and require more in terms of execution time and processor resources, for example, load/store operations or data moves. Therefore, improving the execution time of cycle heavy operations, commit and rollback for example, could improve timing and throughput.

In one embodiment, an instruction set architecture (ISA) may be implemented by one or more micro-architectures, which includes processor logic and circuits used to implement one or more instruction sets. Accordingly, processors with different micro-architectures can share at least a portion of a common instruction set. For example, the same register architecture of the ISA may be implemented in different ways in different micro-architectures using new or well-known techniques, including dedicated physical registers, one or more dynamically allocated physical registers using a register renaming mechanism (e.g., the use of a Register Alias Table (RAT)), a Reorder Buffer (ROB) and a retirement register file. In one embodiment, registers may include one or more registers, register architectures, register files, or other register sets that may or may not be addressable by a software programmer.

In one embodiment, destination and source registers/data are generic terms to represent the source and destination of the corresponding data or operation. In some embodiments, they may be implemented by registers, memory, or other storage areas having other names or functions than those depicted. In one embodiment, one of the source registers may also act as a destination register by, for example, writing back the result of an operation performed on the first and second source data to one of the two source registers serving as a destination registers.

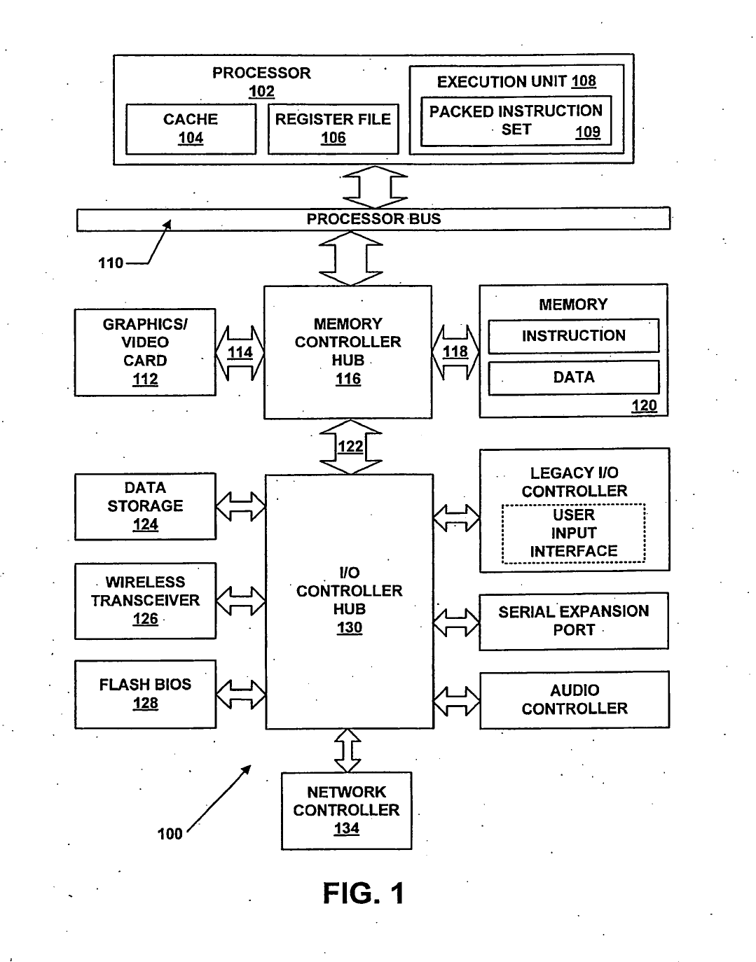

FIG. 1 is a block diagram of an exemplary computer system formed with a processor that includes a memory storage array in accordance with one embodiment of the present invention. System 100 includes a component, such as a processor 102 to employ execution units including logic to perform algorithms for process data. Embodiments of the present invention are not limited to any specific combination of hardware circuitry and software.

Embodiments are not limited to computer systems. Alternative embodiments of the present invention can be used in other devices such as handheld devices and embedded applications. Some examples of handheld devices include cellular phones, Internet Protocol devices, digital cameras, personal digital assistants (PDAs), and handheld PCs. Embedded applications can include a micro controller, a digital signal processor (DSP), system on a chip, network computers (NetPC), set-top boxes, network hubs, wide area network (WAN) switches, or any other system that implements a storage array managed in accordance with at least one embodiment.

FIG. 1 is a block diagram of a computer system 100 formed with a processor 102 that includes a register file 106 managed in accordance with an embodiment of the present invention. One embodiment may be described in the context of a single processor desktop or server system, but alternative embodiments can be included in a multiprocessor system. System 100 is an example of a ‘hub’ system architecture. The computer system 100 includes a processor 102 to process data signals. The processor 102 can be a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. The processor 102 is coupled to a processor bus 110 that can transmit data signals between the processor 102 and other components in the system 100. The elements of system 100 perform their conventional functions that are well known to those familiar with the art.

In one embodiment, the processor 102 includes a Level 1 (L1) internal cache memory 104. Depending on the architecture, the processor 102 can have a single internal cache or multiple levels of internal cache. Alternatively, in another embodiment, the cache memory can reside external to the processor 102. Other embodiments can also include a combination of both internal and external caches depending on the particular implementation and needs. Register file 106 can store different types of data in various registers including integer registers, floating point registers, status registers, and instruction pointer register. In an embodiment, the register file 106 may be implemented as a storage array having a connected shadow element for managing commit and rollback operations.

Execution unit 108, including logic to perform integer and floating point operations, also resides in the processor 102. The processor 102 also includes a microcode (ucode) ROM that stores microcode for certain macroinstructions. Alternate embodiments of an execution unit 108 can also be used in micro controllers, embedded processors, graphics devices, DSPs, and other types of logic circuits.

System 100 includes a memory 120. Memory 120 can be a dynamic random access memory (DRAM) device, a static random access memory (SRAM) device, flash memory device, or other memory device. Memory 120 can store instructions and/or data represented by data signals that can be executed by the processor 102.

A system logic chip 116 is coupled to the processor bus 110 and memory 120. The system logic chip 116 in the illustrated embodiment is a memory controller hub (MCH). The processor 102 can communicate to the MCH 116 via a processor bus 110. The MCH 116 is to direct data signals between the processor 102, memory 120, and other components in the system 100 and to bridge the data signals between processor bus 110, memory 120, and system I/O 122. In some embodiments, the system logic chip 116 can provide a graphics port for coupling to a graphics controller 112. The MCH 116 is coupled to memory 120 through a memory interface 118. The graphics card 112 is coupled to the MCH 116 through an Accelerated Graphics Port (AGP) interconnect 114.

System 100 uses a hub interface bus 122 to couple the MCH 116 to the I/O controller hub (ICH) 130. The ICH 130 provides direct connections to some I/O devices via a local I/O bus. The local I/O bus is a high-speed I/O bus for connecting peripherals to the memory 120, chipset, and processor 102. Some examples are the audio controller, firmware hub (flash BIOS) 128, wireless transceiver 126, data storage 124, legacy I/O controller containing user input and keyboard interfaces, a serial expansion port such as Universal Serial Bus (USB), and a network controller 134. The data storage device 124 can comprise a hard disk drive, a floppy disk drive, a CD-ROM device, a flash memory device, or other mass storage device.

For another embodiment of a system, a memory storage array in accordance with one embodiment can be used with a system on a chip. One embodiment of a system on a chip comprises of a processor and a memory. The memory for one such system is a flash memory. The flash memory can be located on the same die as the processor and other system components. Additionally, other logic blocks such as a memory controller or graphics controller can also be located on a system on a chip.

It will be readily appreciated by one of skill in the art that the embodiments described herein can be used with alternative processing systems without departure from the scope of embodiments of the invention.

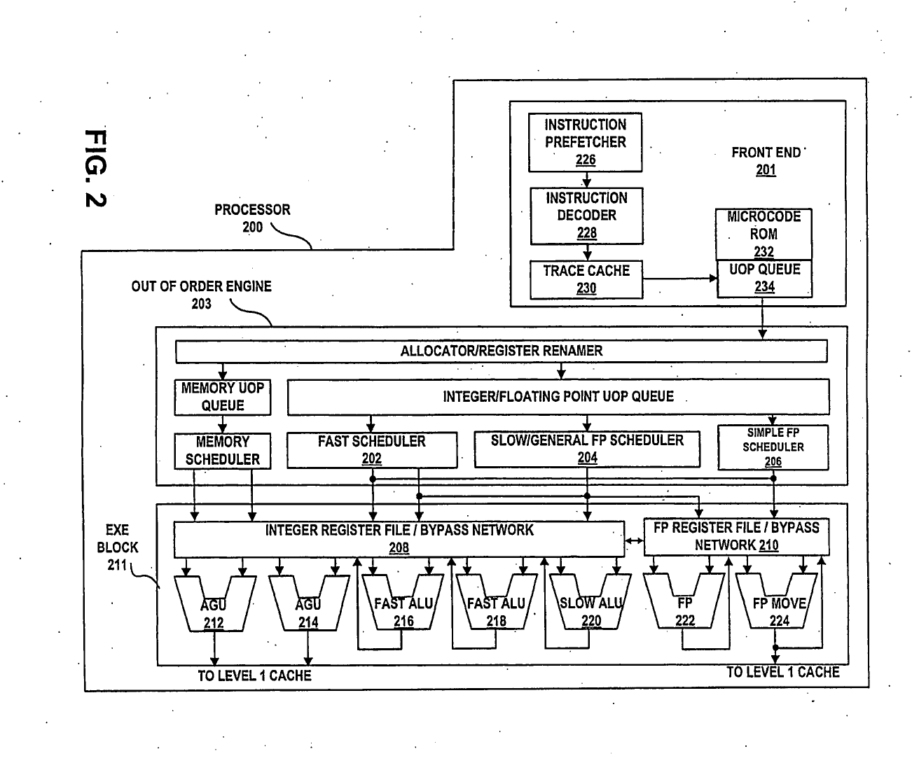

FIG. 2 is a block diagram of the micro-architecture for a processor 200 that includes logic circuits to manage data stored in a storage array in accordance with one embodiment of the present invention. In one embodiment the in-order front end 201 is the part of the processor 200 that fetches instructions to be executed and prepares them to be used later in the processor pipeline. The front end 201 may include several units. In one embodiment, the instruction prefetcher 226 fetches instructions from memory and feeds them to an instruction decoder 228 which in turn decodes or interprets them.

The decode unit or decoder 228 may decode instructions, and generate as an output one or more micro-operations, micro-code entry points, microinstructions, other instructions, or other control signals, which are decoded from, or which otherwise reflect, or are derived from, the original instructions. The decoder may be implemented using various different mechanisms. Examples of suitable mechanisms include, but are not limited to, look-up tables, hardware implementations, programmable logic arrays (PLAs), microcode read only memories (ROMs), etc.

The out-of-order execution engine 203 is where the instructions are prepared for execution. The out-of-order execution logic has a number of buffers to smooth out and re-order the flow of instructions to optimize performance as they go down the pipeline and get scheduled for execution. The allocator logic allocates the machine buffers and resources that each uop needs in order to execute. The register renaming logic renames logic registers onto entries in a register file. The schedulers arbitrate for the dispatch ports to schedule uops for execution.

The execution block 211 contains the execution units 212, 214, 216, 218, 220, 222, 224, where the instructions are actually executed. This section includes the register files 208, 210, that store operand values that the micro-instructions need to execute. The processor 200 of one embodiment is comprised of a number of execution units: address generation unit (AGU) 212, AGU 214, fast ALU 216, fast ALU 218, slow ALU 220, floating point ALU 222, floating point move unit 224. Memory load/store operations are executed by the AGUs 212, 214.

The term “registers” may refer to the on-board processor storage locations that are used as part of instructions to identify operands. In other words, registers may be those that are usable from the outside of the processor (from a programmer's perspective). The registers are not limited to any known particular type of circuit. Various different types of registers are suitable as long as they are capable of storing and providing data as described herein. Examples of suitable registers include, but are not limited to, dedicated physical registers, dynamically allocated physical registers using register renaming, combinations of dedicated and dynamically allocated physical registers, etc.

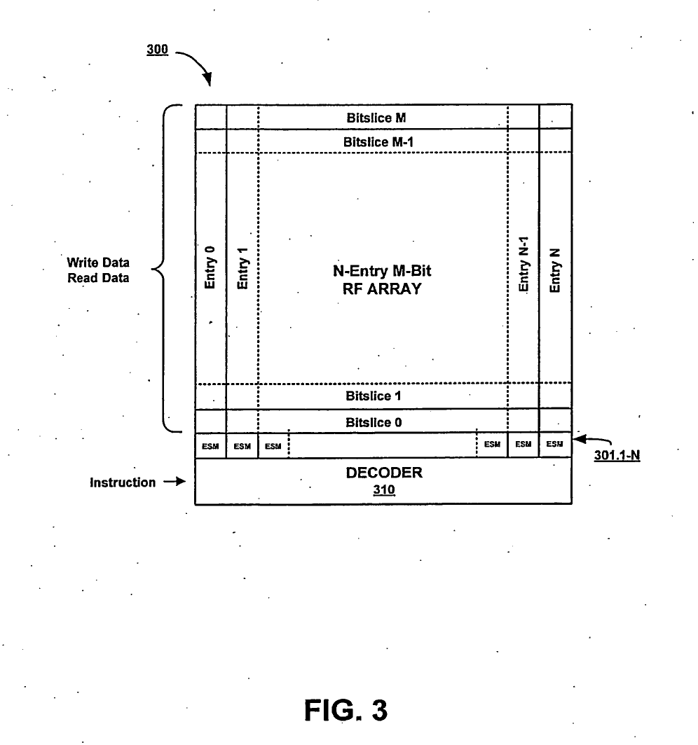

FIG. 3 illustrates an exemplary storage array 300 according to an embodiment. The exemplary storage array 300 may be implemented as a register file in a processor. The storage array 300 may additionally have a connected shadow element used as a backup storage for the entries in the storage array 300. The connected shadow storage element may be implemented according to known techniques for shadowing data.

As shown in FIG. 3, the storage array 300 is an array having N data entries of M bits each. The storage array may be coupled to a decoder 310 and a plurality of entry status monitors (ESMs) 301. Each entry may be implemented with an associated ESM 301.1-N. As previously noted, a decoder 310 may be used for decoding instructions received by the processing core into control signals and/or microcode entry points. The decoder 310 may decode instructions, and generate as an output one or more micro-operations, micro-code entry points, microinstructions, other instructions, or other control signals, which are decoded from, or which otherwise reflect, or are derived from, the original instructions including, for example, a read or write command for the entry at a specific address or a commit or restore command for the storage array 300.

For each entry, the ESM 301 holds a change flag identifying the state of the entry. Then when an entry is written to, the change flag of the corresponding ESM 301 is set to indicate the entry has been changed. Upon a commit or rollback operation, the change flags at each ESM 301 in the storage array 300 are reset to indicate the currently updated status of the entries in the storage array 300. The ESM 301 may control the gating of the commit and rollback signals by limiting the commit and rollback operations to only those entries for which the change flag has been set. When the decoder 310 identifies a commit or rollback command, the commit or rollback signal may be sent to the storage array 300 and passed on only to the entries for which the ESM 301 change flag is set. Then only those entries may be updated.

Utilizing the ESM 301 for a storage array 300 may limit the number of entries that are passed to or from the shadow element when the commit or rollback command is implemented. This may limit the switching activity in signaling wiring and other switching elements in the control network, reduce the average power consumption for the storage array 300, and reduce the peak power consumed during commit and rollback operations.

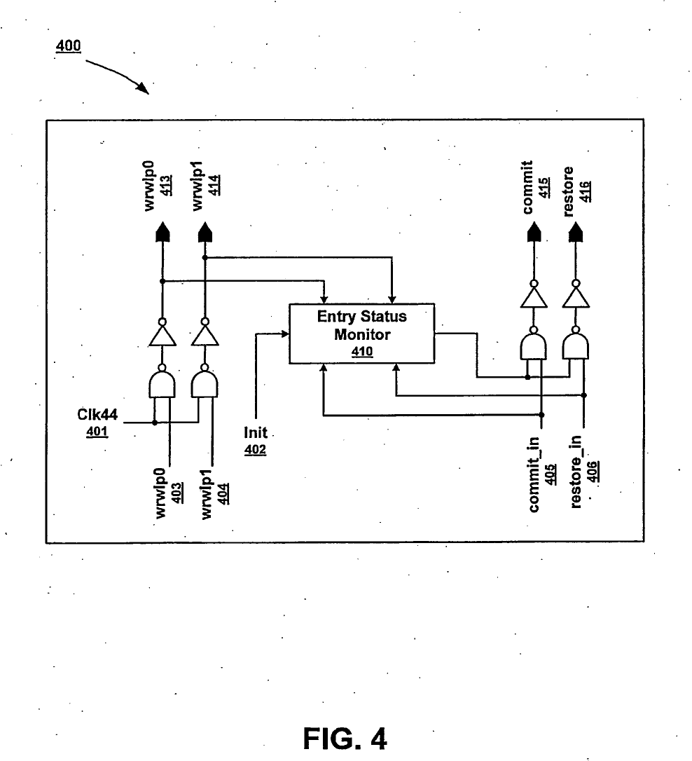

FIG. 4 illustrates exemplary control logic 400 for an entry of a storage array according to an embodiment. As shown in FIG. 4, control logic may include an entry status monitor (ESM) 410 and one or more circuits to control the data passed to the corresponding entry of the storage array and the shadow element. The control logic may receive as input a clock signal 401 to trigger events and manage the timing of the control logic, an initialization signal 402 to enable the ESM 410, write commands for the entry 403, 404, and commit 405 or restore 406 commands. The write commands 403, 404 may include a word to write to the entry. The write command 413, 414, may be passed to the storage array and to the ESM 410 and the change flag of the ESM 410 may be updated to reflect the changed state for the associated entry.

When a commit 405 or restore 404 command is received at the storage array entry, the command may be sent to the ESM 410 and if the ESM 410 entry changed flag is set, the commit 415 or restore 416 command may be passed to the entry to write the entry to or read the entry from a connected shadow storage. Upon receipt of the commit 405 or read 406 command, the ESM 410 change flag may be reset to reflect the updated state of the associated entry. If the ESM 410 entry changed flag is not set, the commit 405 or restore 406 command will not be passed to the entry and nothing will be transmitted to or from the shadow storage for the entry.

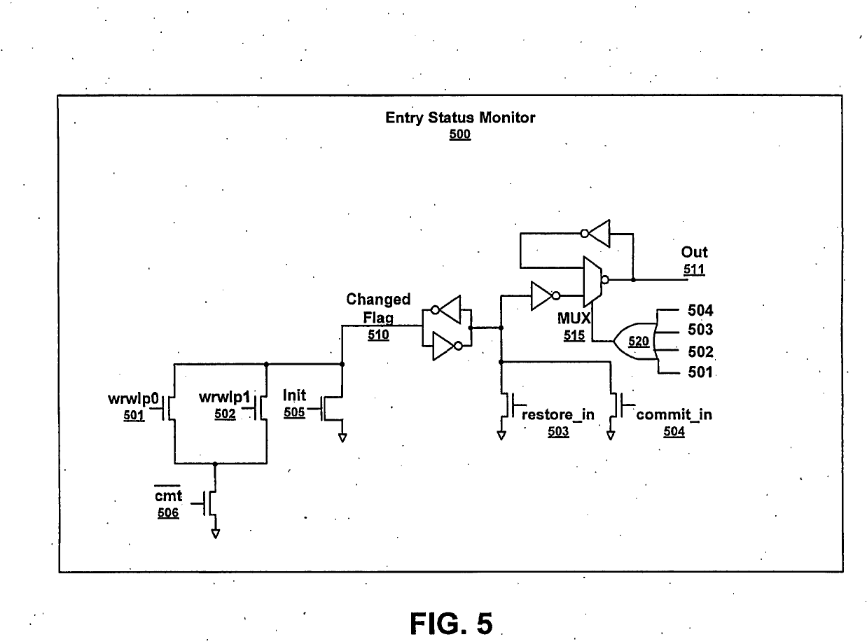

FIG. 5 illustrates an exemplary entry status monitor (ESM) 500 according to an embodiment. As shown in FIG. 5, the ESM 500 may include a plurality of switches that are coupled to a plurality of input signals, and a plurality of circuit elements including an OR gate 520 and a multiplexer (MUX) 515. The MUX 515 may receive as a select signal the output of the OR gate 520 and as inputs the changed flag 510 and a feedback of the output 511. The ESM 500 may receive as inputs the write word commands 501, 502, the restore 503 and commit 504 commands, the initialization signal 505, and a commit complete signal 506. As shown, if the initialization signal 505 or commit complete signal 506 is asserted the associated switch will conduct a current, thereby resetting the changed flag 510. Otherwise the changed flag 510 may be set when the write word commands 501, 502 are asserted.

If either of the write word commands 501, 502, or the restore 503 or commit 504 commands are asserted, then the OR gate 520 will pass a high signal to the MUX 515. The MUX will then select the changed flag 510 as the output 511. As previously noted, the changed flag 510 will be set when the write word commands 501, 502 are asserted. This thereby allows a write-through for entries written to the storage array at the same time the commit or restore operation is implemented. However, if each of the write word commands 501, 502 and the restore 503 and commit 504 commands are low, then the MUX 515 may select as the output the feedback of previous output 511.

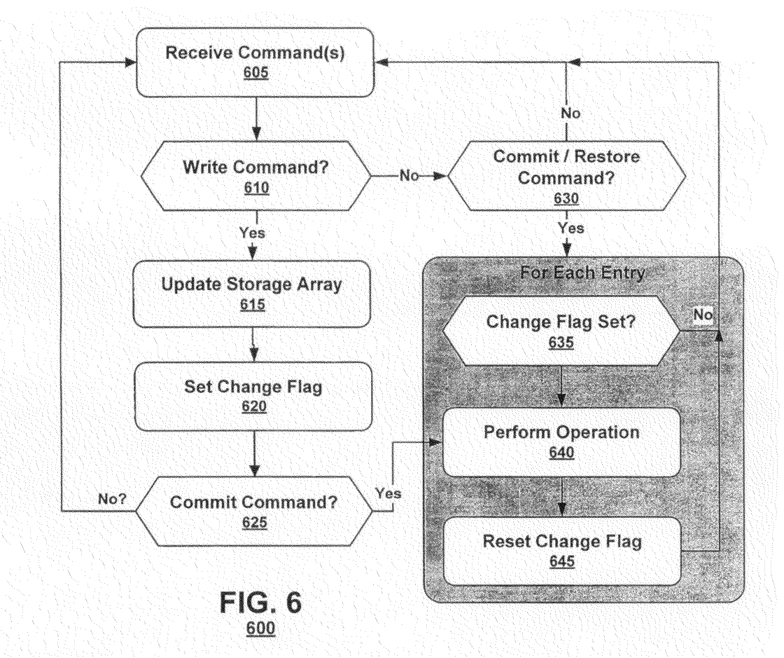

FIG. 6 is a flow diagram that illustrates an exemplary method 600 for managing a storage element according to an embodiment. As shown in FIG. 6, a command may be received at a storage array controller (block 605). If the received command is a write command for an entry (block 610), the new entry may be written (block 615) and the change flag for the entry may be set (block 620).

A command may comprise both a write and a commit command (block 625). Then the new entry may be written to the memory (block 615) and a write-through to the backup memory may be executed by additionally performing the commit operation (block 635) without first checking the change flag.

If the received command includes a request to access a backup or shadow storage element, for example commit or restore command (block 630), the command may be executed for a subset of entries in the primary storage. For each entry for which the received command applies, the controller may determine if the change flag has been set (block 630). If the change flag has not been set, then the data in the entry has not been changed since the last update command and no commit or restore operation is implemented. However if the change flag is set, then the signaled commit or restore operation is implemented to update the data in the entry or the backup (block 635). Once a commit or restore command is implemented, the change flag may be reset to reflect the updated state of the entry (block 640).

Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a memory storage array as disclosed herein are generally suitable.

Additionally, embodiments of the invention disclosed herein may be implemented in FPGAs or similar programmable chips and processing system. Embodiments may also be implemented in intelligent memory devices having control logic implemented as part of the memory system.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

Thus, techniques for performing memory functions according to at least one embodiment are disclosed. While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

1. A method comprising:
receiving an instruction comprising a request to access a backup storage element;
checking a change flag, for each entry in a primary storage for which the request applies, and;
executing the received instruction for each entry for which the respective change flag has been set.

2. The method of claim 1, further comprising:
if the change flag has not been set for an entry, skipping the respective entry when executing the received instruction.

3. The method of claim 1, further comprising:
setting the change flag for an entry in the primary storage upon execution of a write command for the entry.

4. The method of claim 1, further comprising:
resetting the change flag for each entry upon execution of the received instruction.

5. The method of claim 1, wherein the received instruction comprises a commit command.

6. The method of claim 1, wherein the received instruction comprises a restore command.

7. The method of claim 1, wherein the backup storage element comprises a shadow storage element.

8. The method of claim 1, wherein the primary storage element comprises a storage array.

9. The method of claim 1, further comprising:
decoding the instruction; and
passing a command signal to the primary storage.

10. A system comprising:
a first memory unit having a plurality of monitors configured to monitor a change state for each entry in the first memory; and
a second memory unit configured to backup the first memory unit;
wherein upon receipt of a command to access the second memory unit, the command is executed only for the entries in the first memory unit having a change state that indicates the entry has been changed.

11. The system of claim 10, wherein a monitor is configured to set the change state for an entry in the first memory unit to indicate the entry has changed upon execution of a write command for the entry.

12. The system of claim 10, wherein a monitor is configured to reset the change state for an entry in the first memory unit to indicate the entry is current upon execution of the command to access the second memory unit.

13. The system of claim 10, wherein the command to access the second memory unit comprises a commit command.

14. The system of claim 10, wherein the command to access the second memory unit comprises a restore command.

15. The system of claim 10, wherein the second memory unit comprises a shadow storage element.

16. The system of claim 10, wherein the first memory unit comprises a storage array.

17. The system of claim 10, further comprising:
a processor configured to execute the received command.

18. A processor comprising:
a primary memory;
a plurality of monitors, wherein a monitor is coupled to each of a plurality of entries in the primary memory, said monitors configured to monitor a change state of each entry;
a backup memory coupled to the primary memory; and
an execution unit configured to execute a command to access the backup memory for each entry for which the change state indicates the entry has been changed.

19. The processor of claim 18, wherein the plurality of monitors are configured to set the change state for an entry in the primary memory to indicate the entry has changed upon execution of a write command for the entry.

20. The processor of claim 18, wherein the plurality of monitors are configured to reset the change state for an entry in the primary memory to indicate the entry is current upon execution of the command to access the backup memory.

21. The processor of claim 18, wherein the command to access the backup memory comprises a commit command.

22. The processor of claim 18, wherein the command to access the backup memory comprises a restore command.

23. The processor of claim 18, wherein the backup memory comprises a shadow storage element.

24. The processor of claim 18, wherein the primary memory comprises a storage array.

25. The processor of claim 18, further comprising:
a decoder coupled to the primary memory storage, the decoder configured to decode a received instruction and pass the decoded instruction to the execution unit.

26-30. (canceled)
